(19) United States
(12) Patent Application Publication
(10) Pub. No.: US 2014/0305728 A1
(43) Pub. Date: Oct. 16, 2014

(54) COMPACT URBAN VEHICLE

(71) Applicant: ECOLE CENTRALE DE LYON, ECULLY CEDEX (FR)

(72) Inventors: Louis Jezequel, Lyon (FR); Jerome Laborde, Lyon (FR); Patrick Perrard, La Tour De Salvagny (FR)

(21) Appl. No.: 14/356,673

(22) PCT Filed: Nov. 22, 2012
(86) PCT No.: PCT/FR2012/052690

§ 371 Date: May 7, 2014

(30) Foreign Application Priority Data
Nov. 24, 2011 (FR) 1160737

(51) Int. Cl. B62D 31/00; B62D 61/06; B60J 5/02

(52) U.S. Cl. CPC B62D 31/003; B60J 5/02; B62D 61/065
USPC 180/215

(57) ABSTRACT

A three-wheeled vehicle having a chassis with a rear central steered wheel set as its front wheel set, a front right drive wheel, and a front left drive wheel that is independent of the front right drive wheel, the front wheels and the central rear wheel set being arranged in a triangle with a base defined by the front wheels defining the front of the vehicle, and with an apex; a first traction motor driving the front left drive wheel in rotation and a second traction motor driving the front right drive wheel in rotation; a reception floor for receiving users, the floor being supported by the chassis and extending between the front wheels, while opening freely towards the front of the vehicle; bodywork defining, at least over the floor, a cabin that opens to the front between the left and right front wheels; and a door.

The present invention relates to the technical field of motor vehicles and it relates more particularly to motor vehicles of an urban nature.

In the state of the art, various vehicles have been proposed for the purpose of making essentially urban trips.

Thus, by way of example, Document WO 02/18163 describes a vehicle having a chassis with four wheels and two user-receiving seats placed side by side inside a cabin that opens to the front of the vehicle and that is closed by a door that is tiltably mounted.

Patent application FR 2 865 706 describes a motor vehicle having three or four wheels co-operating with a motor-driven rear wheel and two front wheels steered by a steering system. A seat is arranged between the two front wheels so that the legs of the driver overlie the axis passing through the centers of the two front wheels.

U.S. Pat. No. 5,248,011 describes a vehicle having a chassis with two motor-driven front wheels and a steered rear wheel.

In the field of toys, U.S. Pat. No. 6,095,268 discloses a miniature car having a chassis fitted with two driving front wheels that are independent of each other, and with a steered rear wheel.

Those vehicles share the characteristic of seeking to be compact. In practice, it is found that making a vehicle that is compact prevents the vehicle from retaining qualities associated with safety, robustness, and ease of use.

The present invention seeks to propose a novel vehicle of urban nature that is designed to be compact compared with prior art vehicles, while being robust, safe, and easy to use.

To achieve such an object, the vehicle comprises:
a chassis having a rear central steered wheel set and as its front wheel set, a front right drive wheel and a front left drive wheel that is independent of the front right drive wheel, the front wheels and the central rear wheel set being arranged in a triangle with a base defined by the front wheels defining the front of the vehicle, and with an apex defining the rear of the vehicle;
a first traction motor driving the front left drive wheel in rotation and a second traction motor driving the front right drive wheel in rotation, the traction motors being controlled by a control unit;
a reception floor for receiving users, the floor being supported by the chassis and extending between the front wheels, while opening freely towards the front of the vehicle between the left and right front wheels;
bodywork defining, at least over the floor, a cabin that opens to the front between the left and right front wheels; and
a door for closing the front of the cabin, the door being mounted to tilt about a horizontal axis so as to occupy a raised position releasing access to the floor, and a lowered position for closing off access to the floor, the tilting door being fitted with a windshield and with equipment for controlling and driving the vehicle.

Furthermore, the vehicle of the invention may also present at least one and/or another of the following additional characteristics in combination:
the tilting door is fitted with a safety cross-member designed to be locked to the chassis in the lowered position of the door and to extend frontally in front of the cabin;
the tilting door is provided with a bumper for taking up position at the front of the vehicle when the door is in the lowered position;
the tilting door is moved with the help of a mechanism of the motor-driven deformable parallelogram type;
the mechanism of the motor-driven deformable parallelogram type comprises two drive arms, each connected at one of its ends to a motor-driven shaft carried by the chassis and connected by a pivot at its other end to a supporting framework of the tilting door, the mechanism also including at least one connection arm hinged between the chassis and the supporting framework of the door;
the connection arm extends substantially in the middle of the supporting framework of the tilting door, being connected to the safety cross-member and to a front connection cross-member of the supporting framework of the door;
the chassis includes a system for absorbing impacts occurring against the door;
the cabin is fitted with two seats mounted side by side and accessible from the front of the vehicle;
the two seats and the floor are mounted on a raisable structure enabling a space to be disengaged in the cabin, which space is accessible when the door is in the raised position so as to enable the rear of an electric vehicle of the same type to be engaged therein;
the chassis comprises a central rigid structure from which two side rails extend forwards, the floor being positioned between the side rails, the central rigid structure including towards the rear a support structure converging towards the rear central steered wheel set;
for each front drive wheel, the central rigid structure supports resiliently a half-axle connected to a traction motor and also, via a transmission, to the shaft of the front wheel supported by a suspension arm;
the rear central steered wheel set is a bogie that is controllable in pivoting about a vertical axis;
the driving equipment of the vehicle includes a mechanical or electrical steering system; and
the mechanical steering system comprises a steering wheel carried by the safety cross-member of the tilting door, the steering wheel acting on a geartrain for co-operating, when the door is in the lowered position, with a gear of a transmission shaft acting on the rear central steered wheel set.

Various other characteristics appear from the following description made with reference to the accompanying drawings, which show embodiments of the invention by way of non-limiting examples.

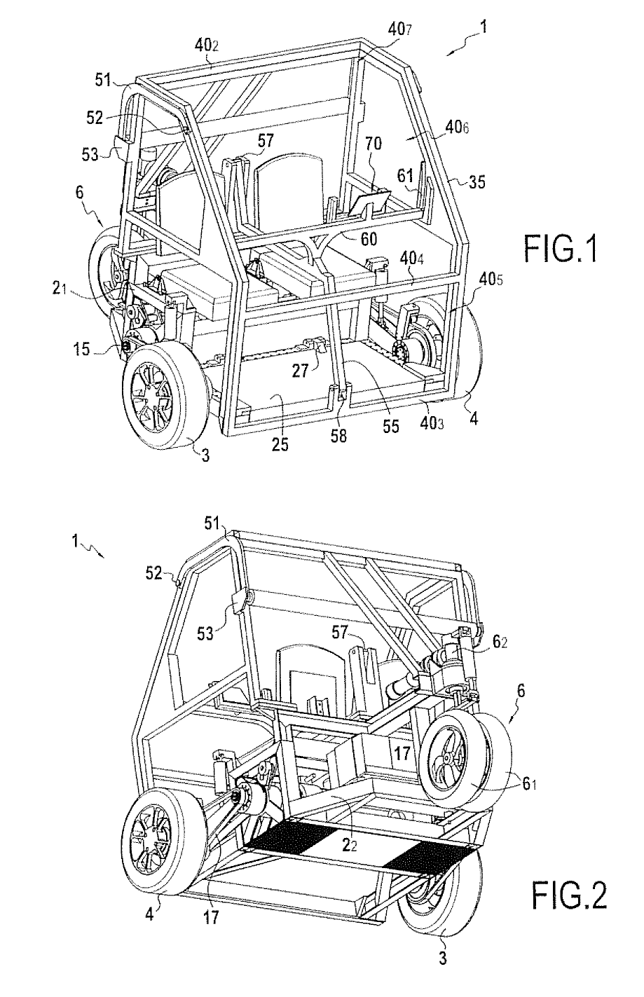

FIGS. 1 and 2 are perspective views of a vehicle in accordance with the invention seen respectively from in front and from behind the vehicle.

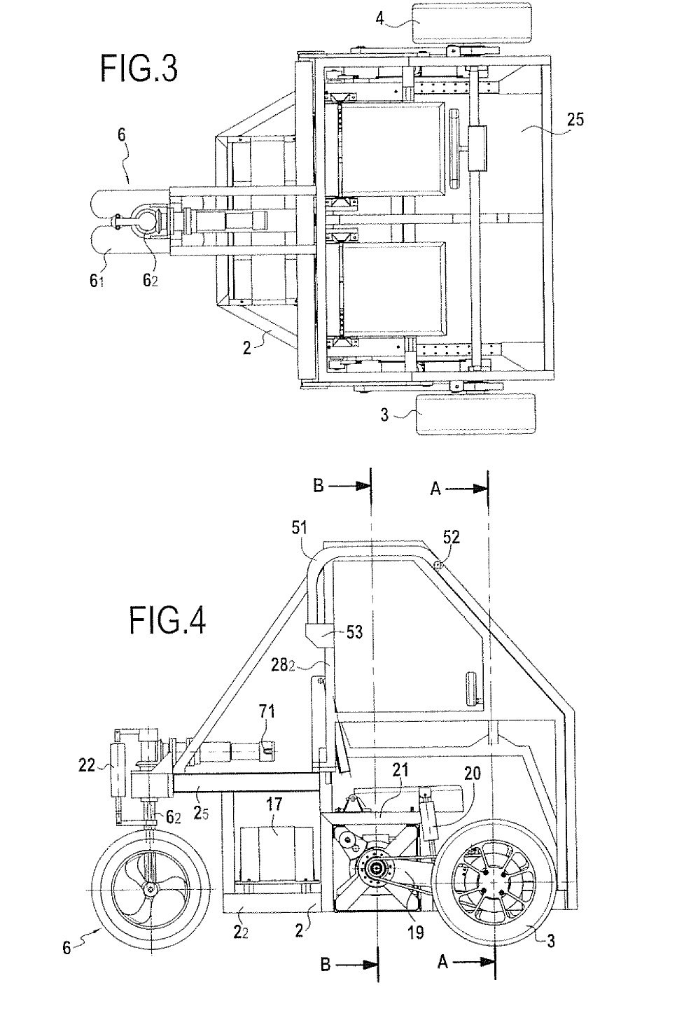

FIG. 3 is a plan view of the vehicle in accordance with the invention.

FIG. 4 is a side view of the vehicle in accordance with the invention.

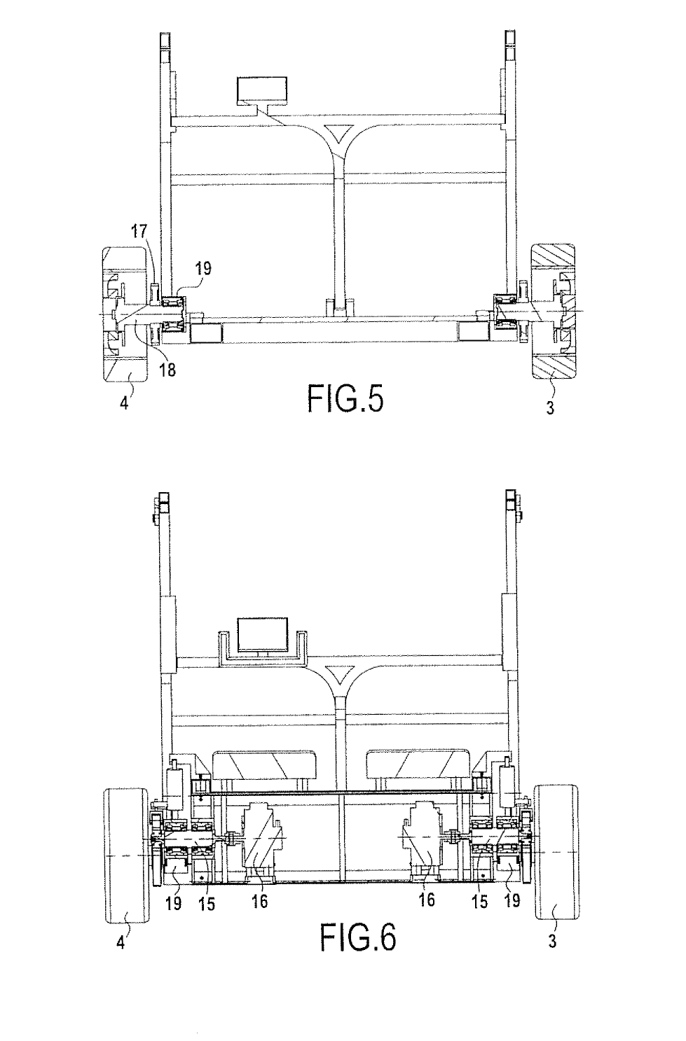

FIGS. 5 and 6 are cross-section views taken respectively on lines A-A and B-B of FIG. 4.

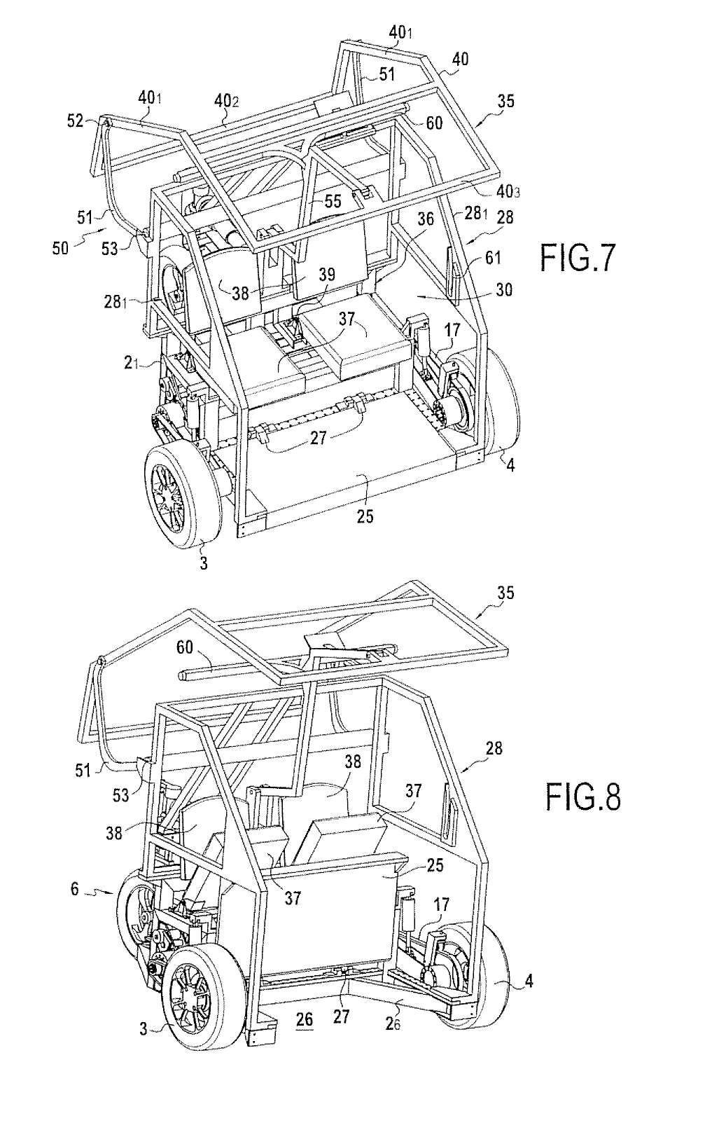

FIG. 7 is a perspective view showing the vehicle with its access door in the raised position.

FIG. 8 is a view analogous to FIG. 7 showing the vehicle with its access door raised and its floor in the raised position.

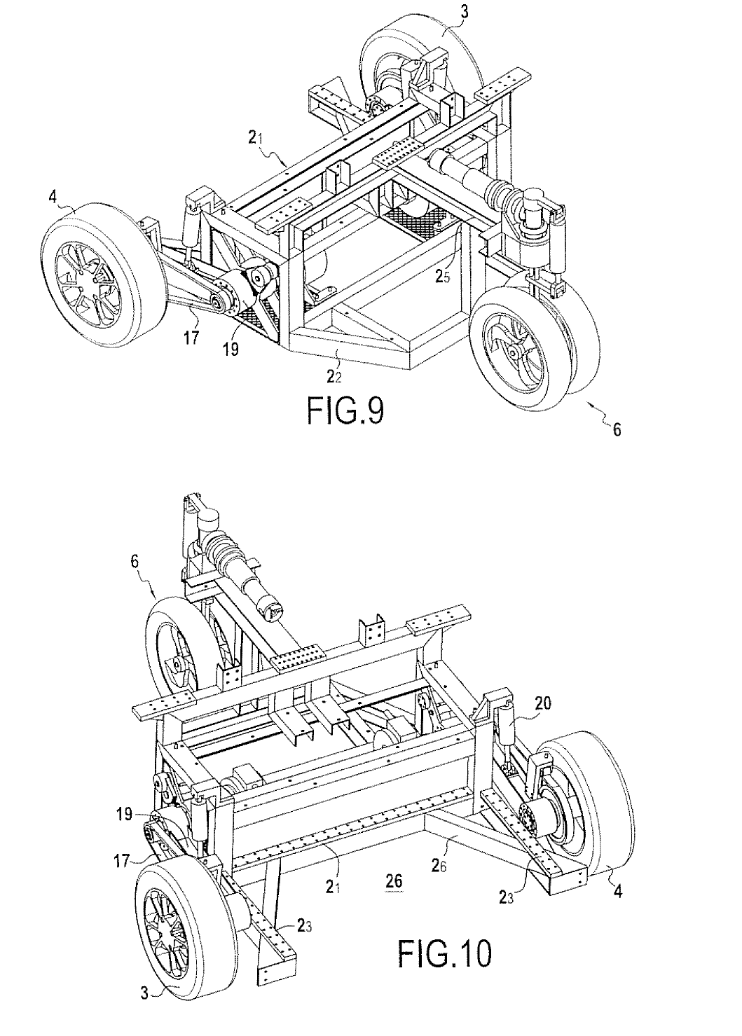

FIGS. 9 and 10 are perspective views showing the mechanized chassis of the vehicle seen respectively from in front and from behind the vehicle.

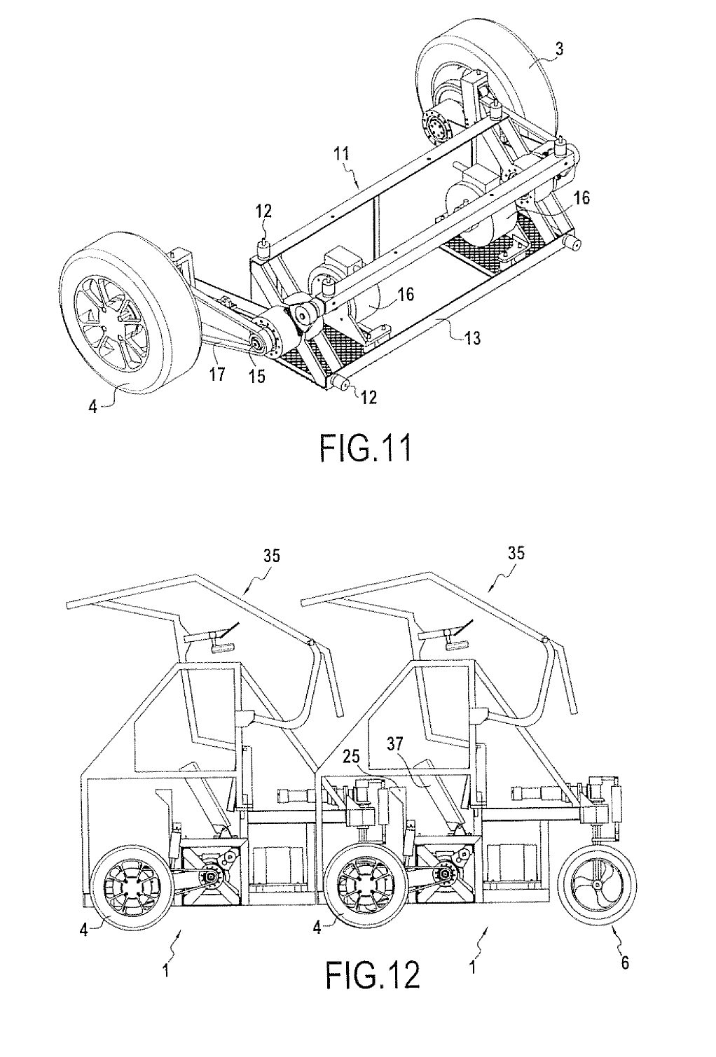

FIG. 11 is a perspective view of the front axle of the vehicle of the invention.

FIGS. 12 to 14 show various configurations for of parking a series of vehicles in accordance with the invention.

As can be seen more clearly in FIGS. 1 to 4, the invention provides a three-wheeled vehicle 1 of generally triangular shape. The vehicle 1 comprises a chassis 2 having as its front wheel set a front right drive wheel 3 and a front left drive wheel 4, where “front” is considered in the normal forward travel direction of the vehicle. As explained in the description below, the front left and right drive wheels 3 and 4 are independent of each other.

The chassis 2 also has a rear central steered wheel set 6. In a preferred embodiment, but not exclusively, the rear central steered wheel set 6 is a bogie having two wheels 6₁, and having a vertical axis 6₂ that is swiveled in controlled manner to pivot the wheels in the horizontal plane in order to steer the vehicle.

The rear wheel set 6 lies halfway between the front wheels 3 and 4, such that the front wheels 3 and 4 and the rear wheel set 6 define a triangle, as can be seen clearly in FIG. 3. The base of this triangle as defined by the front wheels 3 and 4 defines the front of the vehicle, while the apex of the triangle as defined by the rear wheel set 6 corresponds to the rear of the vehicle 1.

In the example shown, the chassis 2 comprises a central rigid structure 2₁ from which a support structure 2₂ extends rearwards, and from which two side rails 2₃ extend forwards, parallel to each other. As can be seen more clearly in FIGS. 9 and 10, the central rigid structure 2₁ is generally in the form of a rectangular parallelepiped extending across the width of the vehicle to act as a housing and as a support, in particular for a motor-driven front axle 11 as shown in FIG. 11. The central rigid structure 2₁ is for resiliently supporting the motor-driven front axle 11 via resilient studs 12.

As shown in FIG. 6, this motor-driven front axle 11 comprises a frame 13 that for each front drive wheel 3, 4, supports a half-axle 15 connected to a traction motor 16 supported by the frame 13. In a preferred variant embodiment, each traction motor 16 is of electric type. For example, the traction motors 16 are connected to a battery pack 17 supported by the support structure 2₂ of the chassis. Naturally, the traction motors 16 could be other than electric motors.

Each half-axle 15 is connected via a transmission 17 to the shaft 18 of a front wheel 3, 4 (FIG. 5). Each shaft 18 of a front wheel 3, 4 is supported by a suspension arm 19 having guide bearings for a half-axle 15.

In a preferred variant embodiment, each suspension arm 19 is connected to the chassis 2 via a suspension system 20 made in any appropriate manner, such as by conventional shock absorbers. In the example shown, each transmission 17 is made as a belt. Naturally, it may be preferred for each drive wheel 3, 4 to be fitted directly with a motor, e.g. an electric motor.

The motor-driven axle 11 is thus supported directly by the chassis 2 by mounting the frame 13 of the motor-driven front axle 11 inside the central rigid structure 2₁. As can be seen clearly in the figures, the suspension arms 19 thus extend parallel to the side rails 2₃ and outside them. The front wheels 3, 4 are positioned to extend so as to be set back a little relative to the ends of the side rails 2₃ (FIG. 4).

In the example shown, the rear central steered wheel set 6 is supported by a bracket 2₅ extending from the support structure 2₂. For reasons of compactness, this support structure 2₂ advantageously converges towards the rear central steered wheel set 6, which is thus suspended relative to the bracket 2₅. Advantageously, the rear central wheel set 6 is fitted with a shock absorber system 22.

According to a characteristic of the invention, the vehicle 1 has a reception floor 25 for receiving the users, which floor is supported by the chassis 2. The floor 25 extends between the front wheels 3, 4, and in particular between the side rails 2₃, opening freely to the front of the vehicle between the left and right front wheels 4 and 3. In other words, the floor 25 is directly accessible from the front of the vehicle 1.

Advantageously, the side rails 2₃ are provided with reinforcements 2₆ for supporting the floor 25. Preferably, the reinforcements 2₆ are fastened at an angle between the central rigid structure 2₁ and each side rail 2₃. The side rails 2₃ and the central rigid structure 2₁ present a generally U-shaped configuration defining between them a free disengaged volume 26 (FIG. 10). The floor 25 is preferably mounted on a raisable structure 27, such as hinges fastened to the central rigid structure 2₁, in order to enable the free volume 26 to be disengaged. Thus, the floor is pivotally mounted from front to rear so that when the floor 25 is raised, the volume 26 between the side rails 2₃ is disengaged.

It should be observed that in the example shown (FIG. 8), the floor 25 is moved manually, however it is clear that the pivoting of the floor could be mechanized. Likewise, the floor 25 is shown as comprising a single plate. Naturally, the floor 25 could be made in two portions. Under such circumstances, it is possible to envisage the two portions of the floor 25 being hinged not from front to rear but rather to the side rails 2₃ so as to pivot laterally.

The vehicle 1 of the invention also includes bodywork 28 defining a cabin 30 above the floor 5, which cabin opens forwards between the front right and front left wheels 3 and 4. In the drawings, the bodywork 28 is represented solely by bars extending longitudinally or transversely in order to show the component elements of the vehicle more clearly, however it is clear that such bodywork is for receiving covering such as protective walls made of any appropriate material. For example, the bodywork 28 comprises two side walls 28₁ extending parallel to each other and substantially over the side rails 2₃ of the chassis. The two side walls 28₁ are connected together at the rear by a rear wall 28₂ extending vertically substantially over the rear face of the central rigid structure 2₁. The side walls 28₁ and the rear walls 28₂ serve to define the cabin 30, which is accessible via a door 35 serving to close the front of the cabin 30. The door 35 is a door mounted to tilt about a horizontal axis in order to occupy a lowered position for closing access to the floor 25 (FIG. 1) and a raised position (FIG. 7) enabling access to the floor 25 to be released in order to allow users to enter or leave the vehicle. The door 35 serves to close and open the front of the vehicle between the front wheels 3 and 4.

In a variant embodiment shown in the drawings, the cabin 30 is fitted with two seats 36 mounted side by side and accessible from the front of the vehicle. The two seats 36 are mounted on the chassis 2 so as to face towards the front of the vehicle. For example, the two seats 36 have respective seats proper 37 mounted over the central rigid structure 2₁ so that users in a sitting position can have their seats resting on the floor 25. The two seats 36 also have backrests 37 extending close to the rear wall 28₂ of the bodywork.

In an advantageous variant embodiment, the seats proper 37 of the seats 36 are mounted on the chassis so as to be raised at least in part towards the rear of the vehicle so as to disengage space towards the front of the vehicle. For example, the seats proper 37 of the seats are mounted on the central rigid structure 2₁ via hinges 39 enabling the seats proper 37 to pivot from front to rear (FIGS. 7 and 8). In the raised position of the seats proper 37, the volume 26 is disengaged.

As shown in the figures, the tilting door 35 extends frontally between the two front wheels 3 and 4 so as to reach the level of the free ends of the side rails 2₁, advantageously in front of them. By way of example, the tilting door 35 is in the form of a supporting framework 40 presenting two uprights 40₁ connected together by a rear cross-member 40₂ and by a front cross-member 40₃ extending parallel to the rear cross-member 40₂. In the lowered position of the door 35, the front cross-member 40₃ is to occupy a position in front of the ends of the side rails 2₁ and the floor 25 (FIG. 1). In the example shown, going from this front cross-member 40₃, the uprights 40₁ extend substantially vertically over a determined height up to an intermediate interconnecting cross-member 40₄ that extends parallel to the front cross-member 40₃. The tilting door 35 thus presents a bumper-forming portion 40₅ between the front and intermediate cross-members 40₃ and 40₄ in order to occupy a position at the front of the vehicle 1 when the door 35 is in its lowered position. Naturally, this bumper-forming portion 40₅ may be adapted to receive various pieces of equipment for absorbing impacts and/or a lighting system, for example.

In a preferred variant embodiment, the chassis 2 has a system for absorbing impacts striking the door 35. For example, the absorber system is mounted on the chassis via the side rails 2₃ in order to take an impact that might occur on the door in the closed position.

Beyond the intermediate cross-member 40₄, the uprights 40₁ slope towards the rear of the vehicle so that the door 35 can be fitted in this location with a windshield 40₆. The uprights 40₁ are extended by respective horizontal portions to the rear cross-member 40₂ to constitute the roof 40₇ of the cabin 30.

In a preferred variant embodiment, the tilting door 35 is moved with the help of a mechanism 50 of the motor-driven deformable parallelogram type. In the example shown, the mechanism 50 has two drive arms 51, each connected at one of its ends via a pivot 52 to the supporting bodywork 40 of the tilting door and at its other end to a motor-driven horizontal shaft 53. Each drive arm 51 thus extends in a plane parallel to a side wall 28₁ of the cabin. The motor-driven shaft 53 thus extends at the level of the rear wall 28₂. The pivot 52 between each internal arm 51 and the tilting door 35 is provided on the upright 40₁ of the supporting framework 40, and in particular at the top of the windshield-forming portion 40₆.

The mechanism 50 also has a connection arm 55 hinged between the chassis 2 and the supporting framework 40 of the tilting door 35. In a preferred variant embodiment, the connecting arm 55 extends substantially in the middle of the tilting door, i.e. between the two seats 36. This connecting arm 55 is hinged firstly via a pivot 57 formed on the chassis at the rear wall 28₂, and secondly via a pivot 58 formed on the front connection cross-member 40₃ of the supporting framework 40. In this embodiment, the mechanism 50 serves to limit the space occupied by the tilting door 35 when in the raised position. Naturally, it is possible to envisage making a mechanism of the deformable parallelogram type having some greater number of connection arms and pivots.

According to an advantageous embodiment characteristic, the tilting door 35 is fitted with a safety cross-member 60 designed to be locked to the chassis 2 when the door is in its lowered position and to extend frontally in front of the cabin 30. As can be seen more clearly in FIGS. 1 and 7, when the door 35 is in the lowered position, the ends of the safety cross-member 60 are designed to engage in locking housings 61 formed on the vertical wall 28₁ of the chassis. In the lowered position, the safety cross-member 60 is locked via its two ends to the chassis 2, extending inside the cabin and set back from the supporting framework 40. Advantageously, each of the locking housings 61 is provided in the form of a slideway suitable for receiving a respective end of the safety cross-member 60 during the movement of the door 35 being lowered. In a preferred variant embodiment, the safety cross-member 60 is mounted on the connection arm 55. For example, when the door 35 is in the lowered position, the connection arm 55 has a horizontal portion on which the safety cross-member 60 is fastened. The horizontal portion of the connection arm 55 is extended by connection portions sloping in opposite directions for connection respectively to the pivots 57 and 58.

The safety cross-member 60 is adapted to support equipment 70 for controlling and driving the vehicle. The safety cross-member 60 may advantageously be provided with a covering to constitute the dashboard of the vehicle. The equipment 70 for driving the vehicle serves to control a control unit for controlling the traction motors 16. The control and driving equipment 70 includes a mechanical or electrical steering system. With a steering system that is mechanical, the system includes a steering wheel carried by the safety cross-member 60. The steering member acts on a geartrain that serves, when the door is in its lowered position, to co-operate with a gear on a shaft extending between the seats to a coupling system 71 acting on the rear steered wheel set 6. Turning the steering wheel thus acts via this mechanical linkage to swivel this rear steered wheel set 6.

From the above description, it can be seen that the vehicle 1 of the invention is compact, e.g. having a height of 1.7 meters (m), a length of 1.9 m, and a width of 2 m. Because its chassis 2 is generally triangular in shape and because of the way its door 35 is mounted, such a vehicle, when parking, may interpenetrate with another vehicle 1 of the same type. As can be seen more clearly in FIG. 12, in order to be able to make vehicles 1 interpenetrate with one another, it suffices to place the tilting doors 35 in their raised position and to raise the floors 25 and the seats proper 37 of the seat so that the rear central steered wheel set 6 of one vehicle can be engaged in the empty volume 26 defined between the side rails 2₃ of another vehicle. By way of example, such a configuration makes it possible to shorten the length of the vehicles by at least 30%

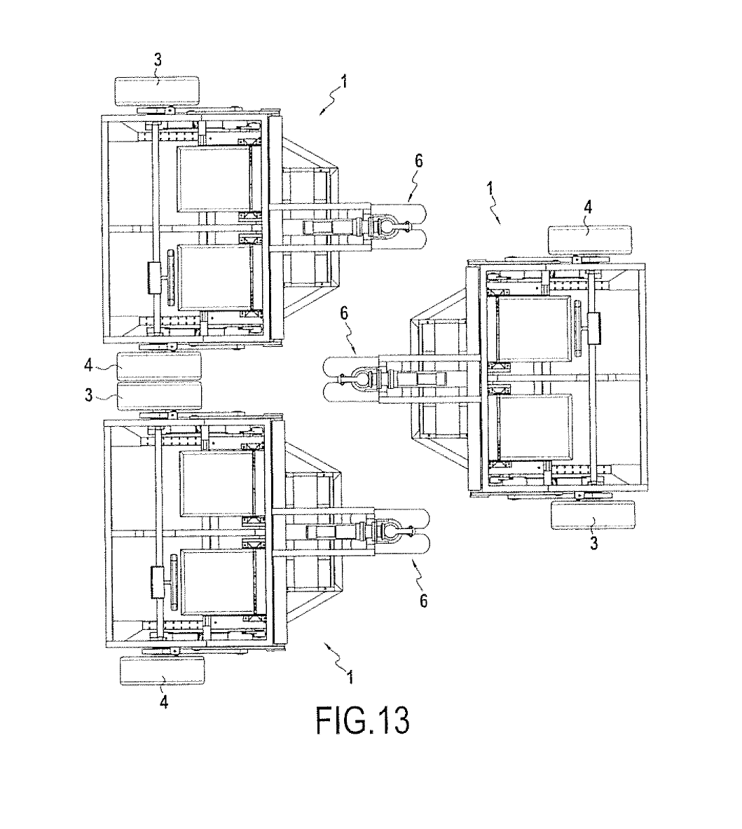

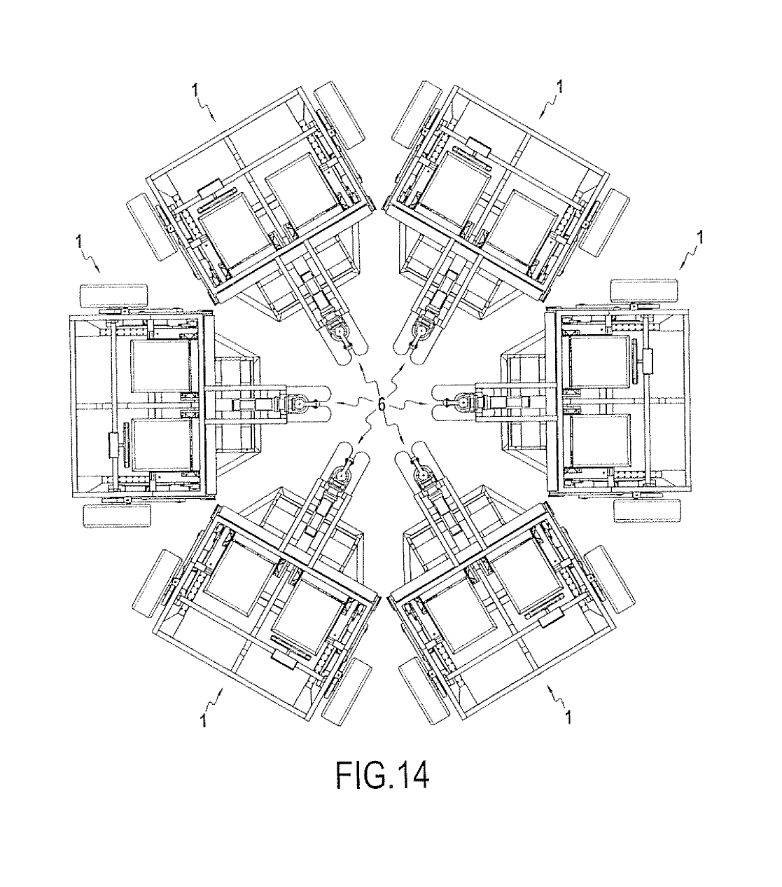

As can be seen more clearly in FIG. 13, it is possible to envisage parking the vehicles 1 in two rows of vehicles facing in opposite directions such that the rear steered wheel set 6 of a vehicle in one row is interposed in the space defined between the rear steered wheel set 6 of two vehicles 1 arranged side by side in another row. As shown in FIG. 14, the vehicles 1 may also be parked in a circle with the rear steered wheel sets 6 of the vehicles towards the center of the circle. For example, provision may be made to place a common electrical recharging point for the vehicles at the center of the circle.

It should be understood that providing a frontally opening door 35 constitutes a distinct advantage enabling users to sit down on or stand up from vehicles seats in the same manner as with an ordinary chair. The users enter the vehicle from the front without being impeded by the door 35. It should be understood that a vehicle 1 could be provided in which the cabin 30 does not have seats 36. Under such circumstances, the floor 25 may be adapted, by way of example, to receive one or two wheelchairs, a child's seat, or a storage bin.

The vehicle 1 of the invention also possesses a rigid survival cell constituted by the chassis 2 and the safety cross-member 60, which is secured to the chassis when the tilting door 35 is in the closed position.

The invention is not limited to the examples described and shown since various modifications can be made thereto without going beyond its ambit.

1. A three-wheeled vehicle, characterized in that it comprises:
a chassis (2) having a rear central steered wheel set (6) and as its front wheel set, a front right drive wheel (3) and a front left drive wheel (4) that is independent of the front right drive wheel, the front wheels (3, 4) and the central rear wheel set (6) being arranged in a triangle with a base defined by the front wheels defining the front of the vehicle, and with an apex defining the rear of the vehicle;
a first traction motor (16) driving the front left drive wheel (4) in rotation and a second traction motor (16) driving the front right drive wheel (3) in rotation, the traction motors (16) being controlled by a control unit;
a reception floor (25) for receiving users, the floor being supported by the chassis and extending between the front wheels (3, 4), while opening freely towards the front of the vehicle between the left and right front wheels;
bodywork (28) defining, at least over the floor (25), a cabin (30) that opens to the front between the left and right front wheels (3, 4); and
a door (35) for closing the front of the cabin, the door being mounted to tilt about a horizontal axis (37) so as to occupy a raised position releasing access to the floor, and a lowered position for closing off access to the floor, the tilting door being fitted with a windshield (406) and with equipment (70) for controlling and driving the vehicle.

2. A vehicle according to claim 1, characterized in that the tilting door (35) is fitted with a safety cross-member (60) designed to be locked to the chassis (2) in the lowered position of the door and to extend frontally in front of the cabin.

3. A vehicle according to claim 1, characterized in that the tilting door (35) is provided with a bumper for taking up position at the front of the vehicle when the door is in the lowered position.

4. A vehicle according to claim 1, characterized in that the tilting door (35) is moved with the help of a mechanism (50) of the motor-driven deformable parallelogram type.

5. A vehicle according to claim 4, characterized in that the mechanism (50) of the motor-driven deformable parallelogram type comprises two drive arms (51), each connected at one of its ends to a motor-driven shaft (53) carried by the chassis and connected at its other end by a pivot (52) to a supporting framework (40) of the tilting door, the mechanism (50) also including at least one connection arm (55) hinged between the chassis (2) and the supporting framework (40) of the door.

6. A vehicle according to claim 5, characterized in that the connection arm (55) extends substantially in the middle of the supporting framework (40) of the tilting door (35), being connected to the safety cross-member and to a front connection cross-member (403) of the supporting framework (40) of the door.

7. A vehicle according to claim 1, characterized in that the chassis (2) includes a system for absorbing impacts occurring against the door.

8. A vehicle according to claim 1, characterized in that the cabin (30) is fitted with two seats (36) mounted side by side and accessible from the front of the vehicle.

9. A vehicle according to claim 8, characterized in that the two seats (36) and the floor (25) are mounted on a raisable structure (27, 39) enabling a space (26) to be disengaged in the cabin, which space is accessible when the door is in the raised position so as to enable the rear of an electric vehicle of the same type to be engaged therein.

10. A vehicle according to claim 1, characterized in that the chassis (2) comprises a central rigid structure (21) from which two side rails (23) extend forwards, the floor being positioned between the side rails, the central rigid structure (21) including towards the rear a support structure (23) converging towards the rear central steered wheel set (6).

11. A vehicle according to claim 10, characterized in that, for each front drive wheel (3, 4), the central rigid structure (21) supports resiliently a half-axle (15) connected both to a traction motor (16) and also, via a transmission (17), to the shaft (18) of the front wheel (3, 4) supported by a suspension arm (13).

12. A vehicle according to claim 1, characterized in that the rear central steered wheel set (6) is a bogie (62) that is controllable in pivoting about a vertical axis.

13. A vehicle according to claim 1, characterized in that the driving equipment of the vehicle (70) includes a mechanical or electrical steering system.

14. A vehicle according to claim 13, characterized in that the mechanical steering system comprises a steering wheel carried by the safety cross-member (60) of the tilting door (35), the steering wheel acting on a geartrain for co-operating, when the door is in the lowered position, with a gear of a transmission shaft acting on the rear central steered wheel set (6).
